(19) United States
(12) Patent Application Publication
(10) Pub. No.: US 2013/0067365 A1
(43) Pub. Date: Mar. 14, 2013

(54) ROLE BASED USER INTERFACE FOR LIMITED DISPLAY DEVICES

(71) Applicants: Adel Shrufi, Bellevue, WA (US); Jeffrey Wallis, Redmond, WA (US); Gregory E. Ozawa, Redmond, WA (US); Teresa B. Ostle, Issaquah, WA (US)

(72) Inventors: Adel Shrufi, Bellevue, WA (US); Jeffrey Wallis, Redmond, WA (US); Gregory E. Ozawa, Redmond, WA (US); Teresa B. Ostle, Issaquah, WA (US)

(73) Assignee: MICROSOFT CORPORATION, Redmond, WA (US)

(21) Appl. No.: 13/231,621

(22) Filed: Sep. 13, 2011

(51) Int. Cl. G06F 3/048

(52) U.S. Cl. 715/764

(57) ABSTRACT

A role based graphical user interface (UI) is used for receiving user input for entry/editing relating to projects/tasks using a limited display device. Functional components are grouped into logical hubs that may be displayed within the user interface. The groupings of the components are based on a role of a user (e.g. project manager, project participant, contractor, . . . ). For example, for one or more users, the role based graphical UI may group the following components together: expense entry and approval; time entry and approval; notification messages; collaboration of information (e.g. documents, project information, and the like); reporting; and settings. After selecting one of the components from the role based UI, a user may use a displayed component for interacting with the functionality (e.g. entering an expense, time entry, . . . ). The UI is configured to allow navigation between the different functions included within the logical hubs.

### BACKGROUND

Limited display devices, such as smart phones, are increasingly being used to perform tasks traditionally performed using desktop computing devices with larger screens. Performing some tasks on a limited display device, however, are cumbersome for a user. For example, it may be difficult for a user to perform project tasks on a limited display device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A role based graphical user interface (UI) is used for receiving user input for entry/editing relating to projects/tasks using a limited display device. Functional components are grouped into logical hubs that may be displayed within the user interface. The groupings of the components are based on a role of a user (e.g. project manager, project participant, contractor, . . . ). For example, for one or more users, the role based graphical UI may group the following components together: expense entry and approval; time entry and approval; notification messages; collaboration of information (e.g. documents, project information, and the like); reporting; and settings. After selecting one of the components from the role based UI, a user may use a displayed component for interacting with the functionality (e.g. entering an expense, time entry, . . . ). The UI is configured to allow navigation between the different functions included within the logical hubs.

### BRIEF DESCRIPTION OF THE DRAWINGS

FIG. 1 illustrates an exemplary computing device;

FIG. 2 illustrates an exemplary system that includes a display for interacting with a role-based UI on a screen of a limited display device;

FIG. 3 shows an illustrative processes relating to a role based User Interface;

FIG. 4 shows example layouts of a role based UI;

FIG. 5 shows a top level display used to access a role based UI;

FIG. 6 shows a component screen for entering an expense;

FIG. 7 shows a component screen for entering a time entry; and

FIG. 8 shows a screen for entering a project identifier.

### DETAILED DESCRIPTION

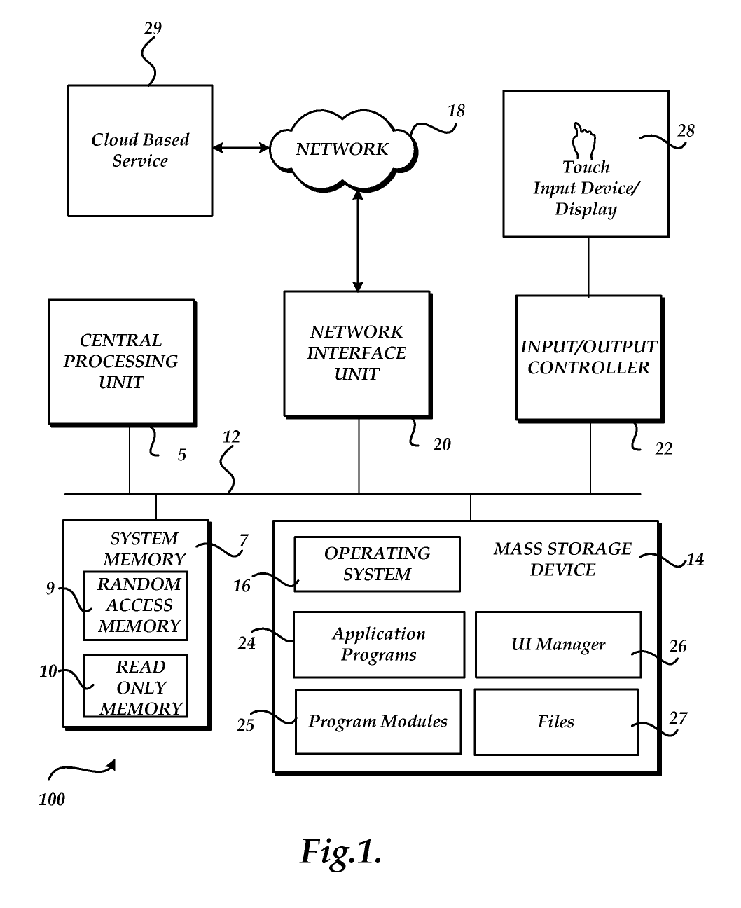

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a mobile computing device (e.g. smartphone, notebook, tablet . . . ) or desktop computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application programs 24, and other program modules 25, files 27 and UI manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a touch input device 28. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device 28 may also act as a display. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, with respect to the Unified Communications via application-specific logic integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a networked personal computer, such as the WINDOWS 7® operating system from MICROSOFT CORPORATION of Redmond, Wash. According to one embodiment, the operating system is configured to include support for touch input device 28. According to another embodiment, a UI manager 26 may be utilized to process some/all of the touch input that is received from touch input device 28.

The mass storage device 14 and RAM 9 may also store one or more program modules. In particular, the mass storage device 14 and the RAM 9 may store one or more application programs 24, such as application(s) relating to project management. For example, functionality included within MICROSOFT DYNAMICS SL may be used for project management. Computing device 100 may access one or more applications included on computing device 100 and/or included in some other location. For example, computing device 100 may connect to a cloud based service 29 to access functionality accessed using a role based graphical user interface. Computing device 100 may also be configured to access functionality on one or more networked computing devices. In conjunction with the operation of the application(s), UI manager 26 is used displaying and receiving input from a role based UI that groups together commonly used functions/components. Generally, UI manager 26 is configured to assist in displaying, processing and receiving user input for a role based graphical user interface (UI) relating to projects/tasks using a limited display device. Additional details regarding the operation of UI manager 26 will be provided below.

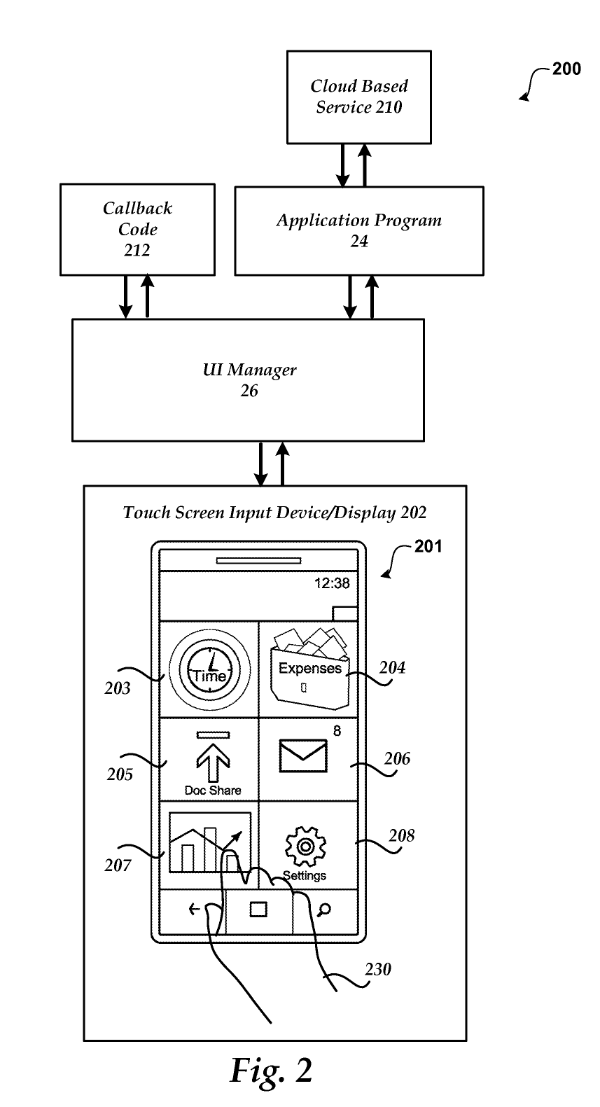

FIG. 2 illustrates an exemplary system that includes a display for interacting with a role-based UI on a screen of a limited display device. As illustrated, system 200 includes application program 24, callback code 212, UI manager 26, cloud based service 210 and touch screen input device/display 202.

In order to facilitate communication with the UI manager 26, one or more callback routines, illustrated in FIG. 2 as callback code 212 may be implemented. According to one embodiment, application program 24 is a business productivity application that is configured to receive input from a touch-sensitive input device 202 and/or keyboard input (e.g. a physical keyboard and/or SIP). For example, UI manager 26 may provide information to application 24 in response to a user's gesture (i.e. finger on hand 230) selecting a user interface option within a role based UI.

System 200 as illustrated comprises a touch screen input device/display 202 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

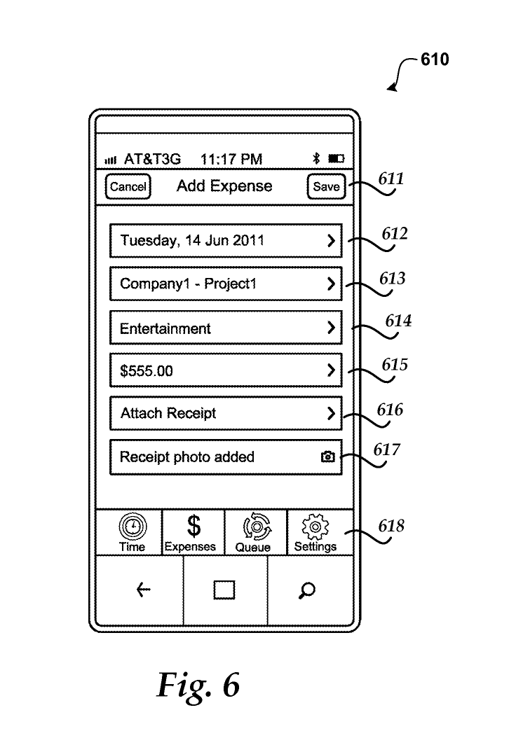

UI manager 26 is configured to display a role based UI and process the received input device/display 202. A role based user graphical user interface (UI) is used for receiving user input for entry/editing relating to projects/tasks. The role based UI 201 groups similar and often-used-together functional components based on a role of a user (e.g. project manager, project participant, contractor, . . . ). For example, for one or more users, the role based user graphical UI may group the following functions together: time component 203; expense component 204; collaboration component 205; notification component 206; reporting component 207; and settings component 208. After selecting one of the components (e.g. by tapping 230 on the display of the component), a user may use the displayed interface for interacting with the functionality (e.g. entering an expense, time entry, . . . ) (See FIGS. 6-8 for example component screens). Generally, time component 203 is used for receiving time entries and/or approval/review of time entries. Expense component 204 is used for entering expenses and/or approval/review of expense entries. Collaboration component 205 is used for sharing/collaborating on information. For example, a user may share a document between project members. Notification component 206 shows a number of notifications pending for a user. IN the example shown, the user has 8 pending notifications. According to an embodiment, the notifications relate to notifications associated with each of the different components. According to another embodiment, all/some of the components within the role based UI may include an indicator that specifies pending notifications with the component. For example, the time component may show a project manager that there are 12 time entries to approve. Reporting component 207 is used to select a report to display. For example, the reports may display a subset of the KPIs (“Key Performance Indicator) to which the user subscribes. Settings 208 is used to configure the settings for the role based UI (e.g. components to display, options displayed).

The cloud based service 210 may be configured to provide cloud based services for a variety of different applications/components access using the role based UI. For example, the cloud based service 210 may be configured to provide business services. According to an embodiment, the services are comparable to the services offered by the MICROSOFT DYNAMICS SL program. The services may include, but are not limited to: financial management, business intelligence and reporting, project management and services management. Some of the different functionality may include time entry, expense review/entry, collaboration of information, notification of tasks/information, reporting, and the like.

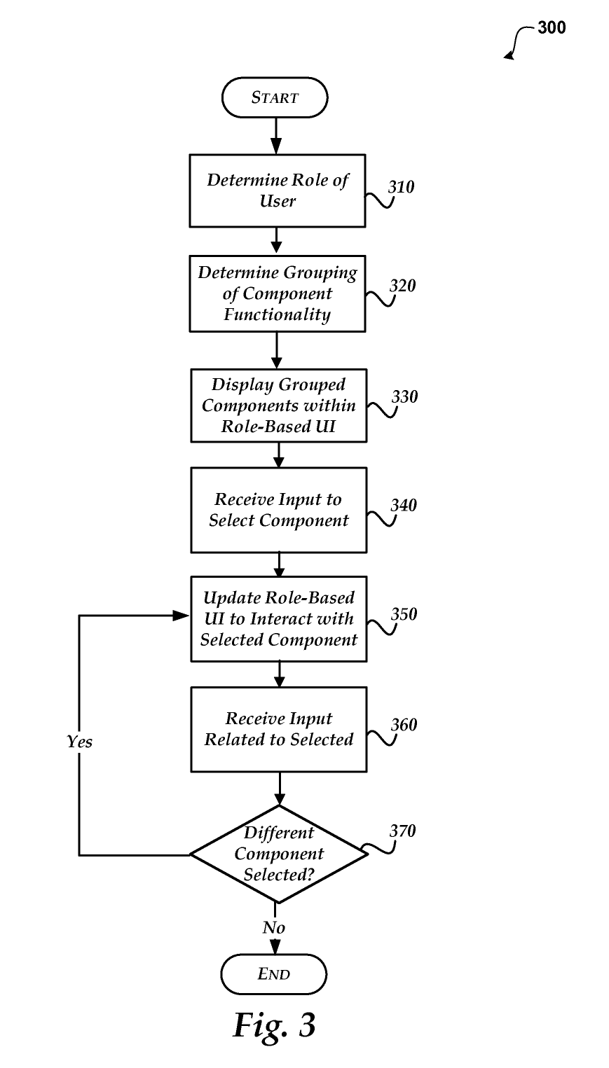

Referring now to FIG. 3 an illustrative processes 300 is described relating to a role based User Interface. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 310, where a role of a user is determined. According to an embodiment, the role relates to tasks assigned to a user in one or more projects. For example, a user may be a project manager, a project member, a contractor, a consultant that is involved in one or more projects.

Moving to operation 320, a grouping of components is determined based on the role of the user. For example, a project member generally has different assigned tasks and responsibilities as compared to a project manager. The components grouped together for the project manager may include components for approving/assigning information whereas the components grouped together for a project member include components for entering information that is approved/reviewed by the project manager. According to an embodiment, the components grouped together for a project member include a time entry component; an expense entry component; a collaboration component; a notification component; a reporting component; and a settings component. According to an embodiment, the components grouped together for a project manager include a time entry and approval component; an expense entry and approval component; a collaboration component; a notification component; a reporting component; and a settings component.

The components may be determined automatically/manually. For example, a user may manually select the components to include within the role-based UI using a user interface and/or setting a configuration file. The components may also be determined automatically be examining a usage pattern of different components for a user. Components may be selected for inclusion within the role based user interface based on the usage pattern. The components may be associated with one or more applications.

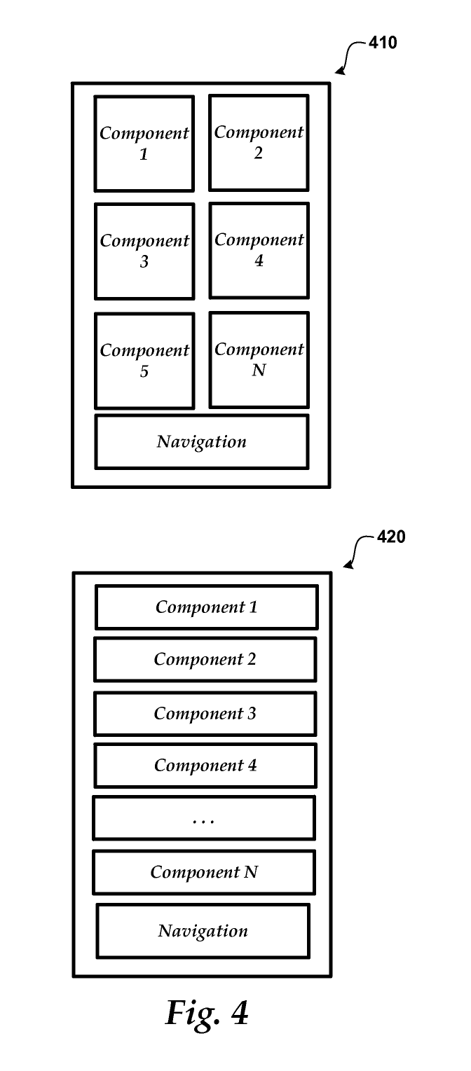

Flowing to operation 330, the grouped components are displayed within a role based UI. The components may be displayed in different manners (e.g. a list, buttons, different icons and the like (See FIGS. 4-8 for examples). According to an embodiment, the role based UI groups components on a single display of a limited display such that commonly used functionality for the user is readily accessible.

Transitioning to operation 340, input is received to select one of the components that is displayed within the role based UI. For example, a user may tap on the component within the display of the role based UI.

Moving to operation 350, the display of the role based UI is updated to reflect the selected component. According to an embodiment, a component screen is displayed to receive input relating to the selected component.

Flowing to operation 360, input is received to interact with the component screen (See FIGS. 6-8 for examples).

Transitioning to decision operation 370, a decision is made to determine whether another component is selected. According to an embodiment, a user may select another component directly from the component screen without having to go back to the main screen of the role based UI.

When another component has bee selected, the process moves to operation 350.

When another component has not been selected, the process flows to an end operation and returns to processing other actions.

FIG. 4 shows example layouts of a role based UI. As illustrated, FIG. 4 includes two different displays (410, 420) that illustrate two different layouts. The displays may be shown on a computing device having a limited display size (e.g. a cell phone having a display of approximately 2 by 3 inches, a tablet having approximately a 7-10 inch display, and/or other devices having other display sizes). According to an embodiment, the displays includes a touch screen that is used to receive gestures to interact with the role based UI.

Displays 410 and 420 each show a role based UI that includes a selection of components chosen based on a role of a user. Any number of a plurality of components for different functionality may be grouped. For example, three, four, five, six, seven, eight, and the like, may be grouped together. According to an embodiment, the grouped components are displayed on a single display screen such that each grouped component can be selected from the same screen. As illustrated each role based UI includes a navigation area that may be used to provide additional functionality that may/may not relate to the role based UI. The navigation area may be include any combination of hardware/software components. For example, the navigation area may be hardware buttons that are part of the computing device. The navigation area could also be an area with programmable software buttons.

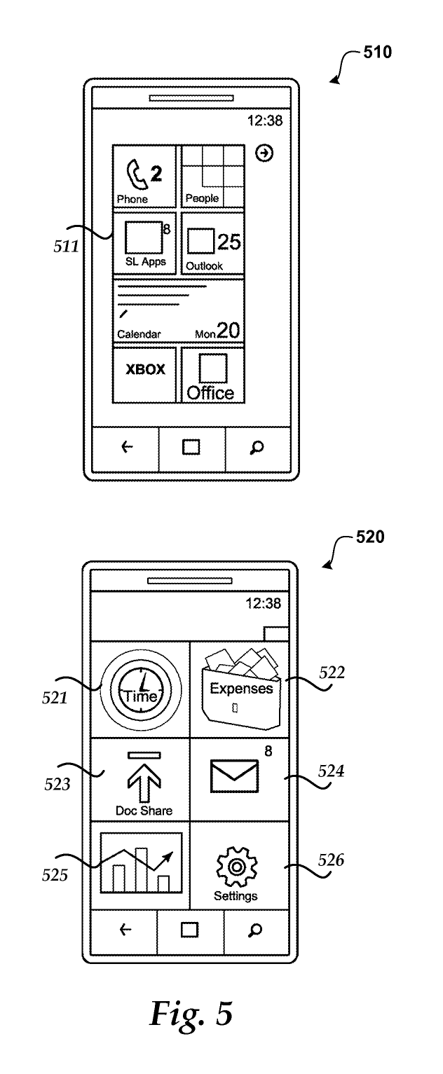

FIG. 5 shows a top level display used to access a role based UI.

Display 510 shows an exemplary screen that may be used to launch the role based UI. Display 510 may be a home screen associated with the device and/or another page on the device. In the example, shown role based UI launch icon 511 shows that 8 messages relating to the role based UI are waiting for the user.

In response to launching the role based UI, display 520 is illustrated. Components 521, 522, 523, 524, 525 and 526 are grouped based on the role of the user. As illustrated, role based UI includes a time component 521, an expense component 522, a collaboration component 523, a notification component 524, a reporting component 525 and a settings component 526. According to an embodiment, the functionality of the components may be configured differently depending on the role of the user. For example a project manager may be allowed to enter and approve entries for various project members whereas a project member may be allowed to enter entries but not approve entries for other project members. Some/all of the components illustrated may change depending on the role of the user. For example, a project manager may include a component for updating tasks that are assigned to project members.

FIG. 6 shows a component screen for entering an expense.

Display 610 shows an exemplary component screen for entering an expense that is launched in response to selecting the expense component on the role based UI (e.g. See FIG. 5). The configuration of the expense component screen may change depending on the role of the user. For example, the expense component screen for a project manager may include an option for reviewing/approving expenses.

As illustrated, expense component screen 610 includes options 611-618 for entering an expense. Option 611 allows a user to save/cancel an expense entry. In response to saving the expense entry, the expense information may be stored. According to an embodiment, the saved expense information is moved to a cloud based service. Option 612 is used to receive entry of a date for the expense. According to an embodiment, the default date is the current date. Option 613 is used to receive an identifier for the project to which the project is to be charged. Option 614 is used to receive a category for the expense. Option 615 is used to receive an amount for the expense. Option 616 is used to receive any notes that the user may want to include with the expense. Option 617 is used to receive an image of the receipt for the expense. Option 618 is used to receive entry to move to another component screen that is associated with the role based UI and/or to change settings that are associated with the expense component and/or the role based UI. For example, the settings option displayed in option 618 may be used to select the default fields that the user would like displayed when the expense component screen is initially displayed.

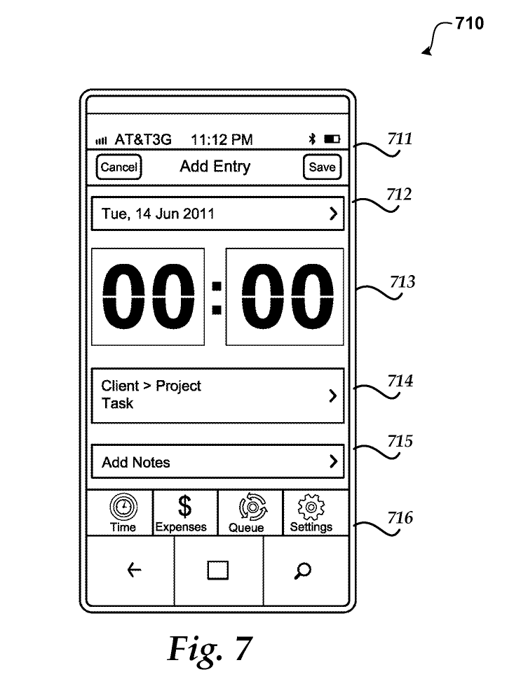

FIG. 7 shows a component screen for entering a time entry.

Display 710 shows an exemplary component screen for entering a time entry that is launched in response to selecting the time component on the role based UI (e.g. See FIG. 5). The configuration of the time component screen may change depending on the role of the user. For example, the time component screen for a project manager may include an option for reviewing/approving time entries for other project members.

As illustrated, time component screen 710 includes options 711-716 for entering a time entry. Option 711 allows a user to save/cancel/start a time entry. According to an embodiment, start button within option 711 may be used to start a timer that may be used to track the time for a time entry (time option 713). According to an embodiment, selecting the start button changes the start button to a stop button that may be used to stop the timer. Once the stop button is selected, the button changes to a save option. Option 712 is used to receive entry of a date for the time entry. According to an embodiment, the default date is the current date. Option 713 is used to receive the time for the time entry. The time may be manually entered or may be determined in response to the timer. Option 714 is used to receive an identifier (e.g. project, task code) for the time entry. Option 715 is used to receive any notes that the user may want to include with the time entry. Option 716 is used to receive entry to move to another component screen that is associated with the role based UI and/or to change settings that are associated with the time component and/or the role based UI. For example, the settings option displayed in option 716 may be used to select the default fields that the user would like displayed when the time component screen is initially displayed.

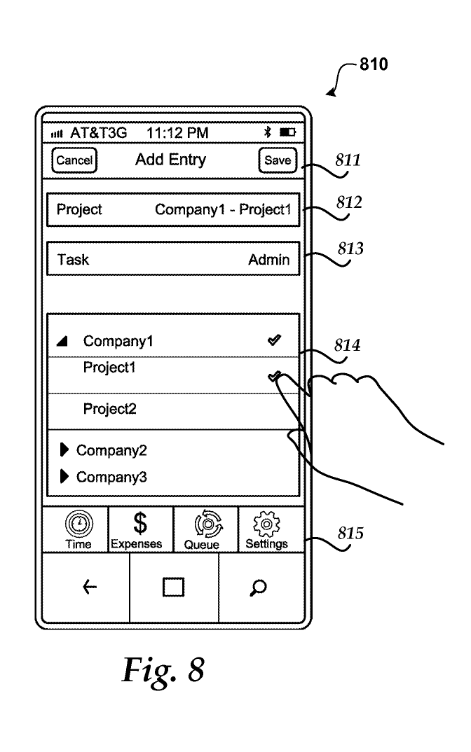

FIG. 8 shows a screen for entering a project identifier.

Display 810 shows an exemplary screen for entering a value in response to selecting an option within a component screen on the role based UI (e.g. See FIGS. 6-7). As illustrated, screen 810 includes options 811-815 for entering a value for the project. Option 811 allows a user to save/cancel a value. Option 812 is used to display a current value for the project. Option 813 is used to display a current value for the task of the project. Option 814 is used to receive a value for a selected option. As illustrated, a user may select a company name and a project. Option 815 is used to receive entry to move to another component screen that is associated with the role based UI and/or to change settings that are associated with the time component and/or the role based UI.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for displaying a role-based user interface (UI) on a limited display device, comprising:
determining a role of a user;
determining a grouping of components including different functionality based on the role of the user;
displaying the grouping of components within the role-based UI on the limited display device;
receiving an input to select one of the components within the grouping of components from the role-based UI; and
updating the role-based UI to display a component screen relating to the selected component.

2. The method of claim 1, further comprising displaying a selectable option for each component with the display of the component screen that when selected updates the display of the component screen to display functionality related to the component that is associated with the selected option.

3. The method of claim 1, wherein the grouping of components comprise an expense component and a time component.

4. The method of claim 1, wherein the grouping of components comprise a notification component that provides notifications related to a project for which the user is a team member, and a report component.

5. The method of claim 1, further comprising accessing a cloud based service in response to receiving input to interact with the selected components.

6. The method of claim 1, further comprising displaying an expense screen in response to receiving a selection of the expense component that includes an option for setting a date of the expense, a project identifier, a category of the expense, an amount of the expense, a note for the expense and a photo of the expense.

7. The method of claim 1, further comprising displaying a time entry screen in response to receiving a selection of the time entry component that includes an option for determining a time duration of a time entry, an option for setting a date of the time entry, a note for the time entry, and an option for entering a project identifier.

8. The method of claim 1, further comprising displaying a collaboration screen in response to receiving a selection of the collaboration component that includes an option for indicating information to share, and an option for configuring options associated with the information to share.

9. The method of claim 1, wherein determining the grouping of components including different functionality based on the role of the user comprises determining tasks assigned to the user that is associated with a project.

10. A computer-readable medium having computer-executable instructions for displaying a role-based user interface (UI) on a limited display device, comprising:
determining a grouping of components including different functionality based on a role of the user in a project;
displaying the grouping of components within the role based UI on the limited display device;
receiving an input to select one of the components within the grouping of components from the role based UI;
updating the role-based UI to display a component screen relating to the selected component; and
updating a cloud based service with information obtained from interaction with the role based UI.

11. The computer-readable medium of claim 10, further comprising displaying a selectable option for each component with the display of the component screen that when selected updates the display of the component screen to display functionality related to the component that is associated with the selected option.

12. The computer-readable medium of claim 10, wherein the grouping of components comprise an expense component, a time component, a notification component that provides notifications related to a project for which the user is a team member and a report component.

13. The computer-readable medium of claim 10, further comprising displaying an expense screen in response to receiving a selection of the expense component that includes an option for setting a date of the expense, a project identifier, a category of the expense and an amount of the expense.

14. The computer-readable medium of claim 10, further comprising displaying a time entry screen in response to receiving a selection of the time entry component that includes an option for determining a time duration of a time entry, an option for setting a date of the time entry, and an option for entering a project identifier.

15. The computer-readable medium of claim 10, further comprising displaying a collaboration screen in response to receiving a selection of the collaboration component that includes an option for indicating information to share, and an option for configuring options associated with the information to share.

16. The computer-readable medium of claim 10, wherein determining the grouping of components including different functionality based on the role of the user comprises determining when the user is a project manager and when the user is a project member.

17. A system for displaying a role-based user interface (UI) on a limited display device, comprising:
a display;
a touch surface that is configured to receive touch input;
a processor and a computer-readable medium;
an operating environment stored on the computer-readable medium and executing on the processor; and
a UI manager operating under the control of the operating environment and operative to:
displaying a grouping of components including different functionality based on a role of the user in a project;
receive an input to select one of the components within the grouping of components from the role based UI;
update the role-based UI to display a component screen relating to the selected component; and
update a cloud based service with information obtained from interaction with the role based UI.

18. The system of claim 17, wherein the grouping of components comprise an expense component, a time component, a notification component that provides notifications related to a project for which the user is a team member and a report component.

19. The system of claim 17, wherein each of the grouped components is displayed on a single screen.

20. The system of claim 17, further comprising displaying a time entry screen in response to receiving a selection of the time component, displaying an expense entry screen in response to receiving a selection of the expense component and a collaboration screen in response to receiving a selection of the collaboration component.
